(19) United States
(12) Patent Application Publication
(10) Pub. No.: US 2025/0230816 A1
(43) Pub. Date: Jul. 17, 2025

(54) Obstacle Avoidance System And Method Thereof

(71) Applicant: AC Infinity Inc., City of Industry, CA (US)

(72) Inventors: Jimmy Liu, Brea, CA (US); Daniel Yu Hsu, Upland, CA (US); Wilbur Y. Cheng, Chino Hills, CA (US); Wei Ying Shao, Alhambra, CA (US)

(21) Appl. No.: 18/411,894

(22) Filed: Jan. 12, 2024

(51) Int. Cl. F04D 25/06; F04D 27/00; G01D 5/347

(52) U.S. Cl. CPC F04D 25/06; F04D 27/008; G01D 5/34738

(57) ABSTRACT

An obstacle avoidance system for a rotary head having a rotating shaft driven by a motor includes a photoelectric encoder and a controller. The controller is electrically coupled to the photoelectric encoder. The photoelectric encoder includes a code disk and a photoelectric sensor. The controller includes an angle detecting unit, an obstacle detecting unit, and a driving circuit. The driving circuit is electrically coupled to the obstacle detecting unit and the angle detecting unit. The driving circuit can set a current angular position as a limit value of a preset rotation range when receiving an obstacle signal from the obstacle detecting unit. A method thereof is also disclosed.

### FIELD OF THE INVENTION

The present invention generally relates to an electric fan and, more particularly, to an obstacle avoidance system and method for a rotary head.

### BACKGROUND OF THE INVENTION

The conventional electric appliance, for example, but not limited to an electrical fan or heater, is restricted to predefined oscillation range right from the moment its fan head starts to swing. It follows a predetermined route to reach its maximum oscillation angle, even if it collides with obstacles like walls.

Moreover, the rotary head repeats the same route in subsequent runs, leading it to repeatedly collide with obstacles. This poses a potential problem when the rotary head encounters barriers during oscillation, as it may result in damage to the mechanism or motor.

### SUMMARY OF THE INVENTION

In order to overcome the disadvantages associated with the aforementioned systems, an obstacle avoidance system for a rotary head having a rotating shaft driven by a motor is disclosed. The obstacle avoidance system includes a photoelectric encoder and a controller. The controller is electrically coupled to the photoelectric encoder. The photoelectric encoder includes a code disk and a photoelectric sensor. The code disk is coaxially mounted on the rotating shaft. The code disk has a plurality of slits within a periphery of the code disk. The photoelectric sensor includes two optoelectronic switches. The two optoelectronic switches are spaced apart and oriented towards the code disk. The two optoelectronic switches can generate two cycle signals when obstructed and when unobstructed by the code disk. The controller includes an angle detecting unit, an obstacle detecting unit, and a driving circuit. The driving circuit is electrically coupled to the obstacle detecting unit and the angle detecting unit. The angle detecting unit can detect angular positions of the code disk by the cycle signals. The obstacle detecting unit can generate an obstacle signal when the cycle signals reach invariant electrical levels. The driving circuit can set a current angular position as a limit value of a preset rotation range when receiving the obstacle signal. And the driving circuit can generate driving signals for the motor based on the preset rotation range.

The obstacle avoidance system may be configured such that the controller further includes a reversing unit. The reversing unit is electrically coupled to the driving circuit. The reversing unit can generate a reversing signal in response to the obstacle signal. The driving circuit can reverse a direction of rotation of the motor.

The obstacle avoidance system may be configured such that the slits are periodically arranged on the code disk, and the angular positions of the code disk can be determined by the cycle signals and a total number of the slits.

The obstacle avoidance system may be configured such that each of the optoelectronic switches can respectively generate the cycle signal including alternative high and low electrical levels. The angle detecting unit can determine a rotating direction of the code disk by a phase difference between the cycle signals.

The obstacle avoidance system may be configured such that the controller further includes a preset unit. The preset unit can reset the limit value of the preset rotation range.

In another aspect, a method for avoiding double impact on obstacles for a rotary head having a rotating shaft driven by a motor is provided. The method includes steps of generating two cycle signals by two optoelectronic switches when obstructed and when unobstructed by a code disk coaxially mounted on the rotating shaft, detecting angular positions of the code disk by the cycle signals, generating an obstacle signal when the cycle signals reach invariant electrical levels, setting a current angular position as a limit value of a preset rotation range when receiving the obstacle signal, and generating driving signals for the motor based on the preset rotation range.

The method may further include steps of generating a reversing signal in response to the obstacle signal and reversing a direction of rotation of the motor.

The step of detecting angular positions of the code disk may further include determining the angular positions by the cycle signals and a total number of the slits that are periodically arranged on the code disk.

The step of detecting angular positions of the code disk may further include determining a rotating direction of the code disk by a phase difference between the cycle signals that include alternative high and low electrical levels.

The method may further include a step of resetting the limit value of the preset rotation range.

### BRIEF DESCRIPTION OF THE DRAWINGS

The drawings illustrate examples. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 shows an exploded perspective view of an embodiment of an obstacle avoidance system for a rotary head having a rotating shaft driven by a motor.

FIG. 2 shows a perspective view of the photoelectric encoder of the obstacle avoidance system shown in FIG. 1.

FIG. 3 shows a circuit block diagram of the controller of the obstacle avoidance system shown in FIG. 1.

FIG. 4 shows a schematic diagram of the photoelectric encoder of the obstacle avoidance system shown in FIG. 1, wherein the code disk rotates in a clockwise direction.

FIG. 5 shows an electrical level-versus-time diagram depicting the cycle signals generated by the photoelectric encoder shown in FIG. 4.

FIG. 6 shows a schematic diagram of the photoelectric encoder of the obstacle avoidance system shown in FIG. 1, wherein the code disk rotates in a counterclockwise direction.

FIG. 7 shows an electrical level-versus-time diagram depicting the cycle signals generated by the photoelectric encoder shown in FIG. 6.

FIG. 8 shows an electrical level-versus-time diagram depicting the cycle signals when the rotary head is operating normally.

FIG. 9 shows an electrical level-versus-time diagram depicting the cycle signals when the rotary head hits an obstacle.

FIG. 10 shows an electrical level-versus-time diagram depicting the operation of the rotary head when it hits an obstacle.

FIG. 11 shows a flowchart of another embodiment of a method for avoiding double impact on obstacles.

### DETAILED DESCRIPTION OF THE PREFERRED EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

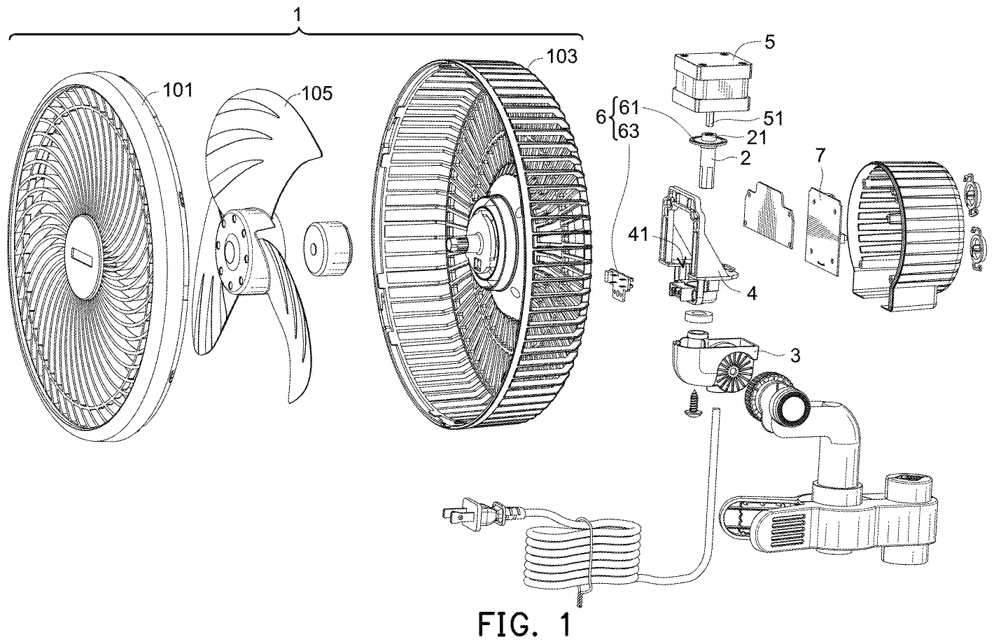

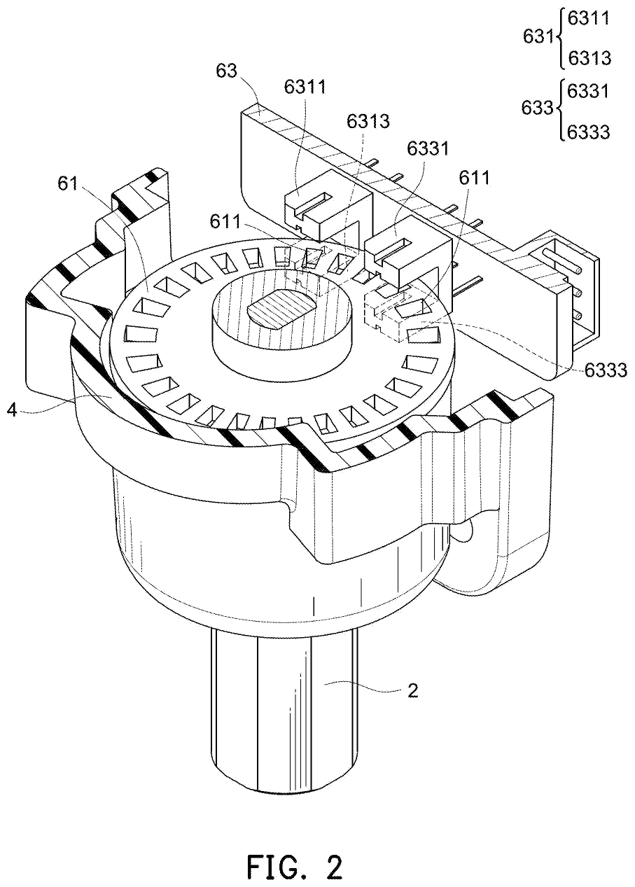

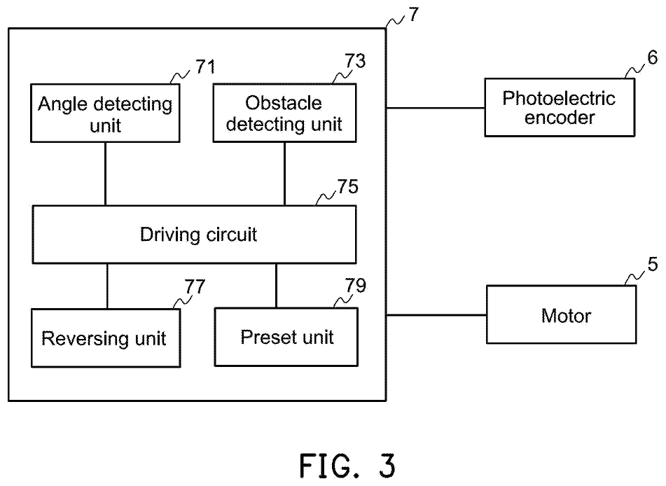

FIG. 1 shows an exploded perspective view of an embodiment of an obstacle avoidance system for a rotary head having a rotating shaft driven by a motor. FIG. 2 shows a perspective view of the photoelectric encoder of the obstacle avoidance system shown in FIG. 1. FIG. 3 shows a circuit block diagram of the controller of the obstacle avoidance system shown in FIG. 1.

Referring to FIGS. 1 to 3 together, in the embodiment, the electric appliance is, but is not limited to, a fan. The fan includes a rotary head 1, a rotating shaft 2, a base 3, a holder 4, a motor 5, and an obstacle avoidance system. The rotary head 1 includes a front cover assembly 101, rear cover assembly 103, and fan blade assembly 105. The rear cover assembly 103 is connected to the front cover assembly 101, accommodating the fan blade assembly 105 inside. The rotary head 1 is rotatably secured to the base 3 through the rotating shaft 2.

The rotating shaft 2 is driven by the motor 5 to rotate the rotary head 1. The rotating shaft 2 rotates either clockwise or counterclockwise within the range of a predetermined oscillation angle.

The holder 4 has an opening 41 for receiving the rotating shaft 2. The motor 5 is secured to the holder 4.

The stepper motor 5 has an output shaft 51. The output shaft 51 extends towards the opening 41 and connects to an end 21 of the rotating shaft 2. In other words, the rotating shaft 2 extends into the holder 4 and connects to the stepper motor 5. In one embodiment, the motor 5 is a stepper motor, but is not limited thereto.

The obstacle avoidance system includes a photoelectric encoder 6 and a controller 7. The controller 7 is electrically coupled to the motor 5 and the photoelectric encoder 6.

The photoelectric encoder 6 includes a code disk 61 and a photoelectric sensor 63. The code disk 61 is coaxially mounted on the rotating shaft 2. Thus, the code disk 61 can rotate along with the rotating shaft 2 as the rotary head 1 rotates relative to the base 3. The code disk 61 has a plurality of slits 611 within a periphery of the code disk 61. The photoelectric sensor 63 includes two photoelectric switches 631, 633, and sensor circuits. The two photoelectric switches 631, 633 are spaced apart and oriented towards the code disk 61. The two photoelectric switches 631, 633 can generate two cycle signals when obstructed and when unobstructed by the code disk 61.

In this embodiment, the two photoelectric switches 631, 633 include transmitters 6311, 6331 and receivers 6313, 6333 facing each other. In one example, the transmitter 6311, 6331 are infrared light emitting diodes, and the receivers 6313, 6333 are NPN phototransistors.

The controller 7 includes an angle detecting unit 71, an obstacle detecting unit 73, and a driving circuit 75. The driving circuit 75 is electrically coupled to the obstacle detecting unit 73 and the angle detecting unit 71. The angle detecting unit 71 can detect angular positions of the code disk 61 by the cycle signals. The obstacle detecting unit 73 can generate an obstacle signal when the cycle signals reach invariant electrical levels. The driving circuit 75 can set a current angular position as a limit value of a preset rotation range when receiving the obstacle signal. In addition, the driving circuit 75 can generate driving signals for the motor 5 based on the preset rotation range.

In some embodiments, the controller 7 can be implemented by one or more of a microprocessor, a microcontroller, a digital signal processor, a microcomputer, a central processing unit, a field programmable gate array, a programmable logic device, a state machine, a logic circuit, an analog circuit, a digital circuit, and/or any processing element that operates signals based on operation instructions.

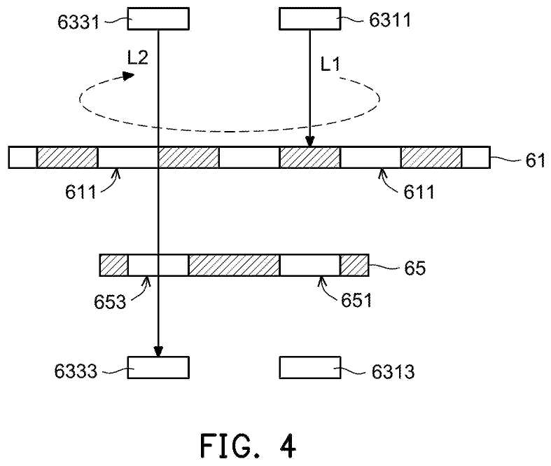

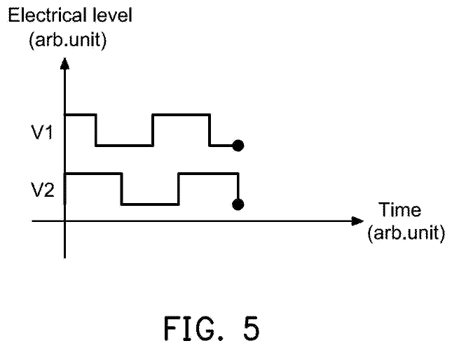

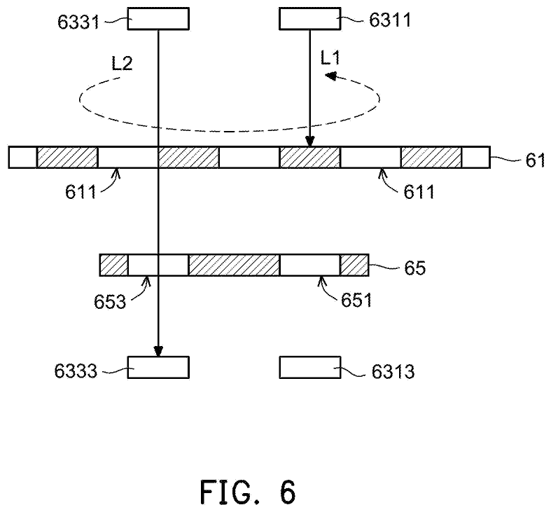

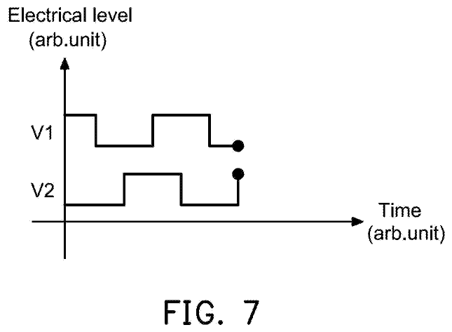

FIG. 4 shows a schematic diagram of the photoelectric encoder of the obstacle avoidance system shown in FIG. 1, wherein the code disk rotates in a clockwise direction. FIG. 5 shows an electrical level-versus-time diagram depicting the cycle signals generated by the photoelectric encoder shown in FIG. 4. FIG. 6 shows a schematic diagram of the photoelectric encoder of the obstacle avoidance system shown in FIG. 1, wherein the code disk rotates in a counterclockwise direction. FIG. 7 shows an electrical level-versus-time diagram depicting the cycle signals generated by the photoelectric encoder shown in FIG. 6.

Referring to FIG. 4, in one embodiment, the photoelectric encoder 6 further includes a stationary filter 65 having adjacent slits 651, 653 above the receivers 6313, 6333. As such, the stationary filter 65 can precisely align the direction of the emitted light L1, L2 from the transmitters 6311, 6331 to the receivers 6313, 6333.

Referring to FIGS. 2, 4, and 5 together, the photoelectric sensor 63 can generate two cycle signals V1, V2, when the code disk 61 rotates clockwise with the rotating shaft 2. For example, the light L1 emitted by the transmitter 6311 is blocked by the body of the code disk 61 and cannot reach the receiver 6313, while the light L2 emitted by the transmitter 6331 passes through the slit 611 of the code disk 61 and reaches the receiver 6333. When the receiver 6313 is obstructed by the code disk 61, it can generate a high electrical level of the cycle signal V1 correspondingly in the absence of the light L1. Conversely, when the receiver 6313 is unobstructed by the code disk 61, it can receive the light L1 from the transmitter 6311 and generate a low electrical level of the cycle signal V1 accordingly. Similarly, the receiver 6333 can generate high and low levels of the cycle signal V2 when obstructed and when unobstructed by the code disk 61. As such, the two receivers 6313, 6333 can generate two cycle signals V1, V2 having alternative high electrical levels and low electrical levels, as shown in FIG. 5, when obstructed and when unobstructed by the code disk 61. That is, each of the photoelectric switches 631, 633 can respectively generate the cycle signal having alternative high and low electrical levels.

Referring to FIGS. 2, 6, and 7 together, the photoelectric sensor 63 can generate two cycle signals V1, V2, when the code disk 61 rotates counterclockwise with the rotating shaft 2. The operating principle and mechanism of the photoelectric sensor 63 is similar to the embodiment in FIG. 4 and will therefore not be repeated again. As such, the two receivers 6313, 6333 can generate two cycle signals V1, V2 having alternative high electrical levels and low electrical levels, as shown in FIG. 7, when obstructed and when unobstructed by the code disk 61.

Comparing FIGS. 5 and 7 reveals that the signal phase difference (delay) between the two cycle signals V1, V2 will vary as the code disk 61 rotates clockwise or counterclockwise. Thus, the controller 7 can detect a change in the direction of rotation of the code disk 61 by calculating the signal phase difference between the two cycle signals V1, V2. Specifically, the angle detecting unit 71 can receive the cycle signals V1, V2 and determine a rotating direction of the code disk 61 according to the phase difference between the two cycle signals V1, V2.

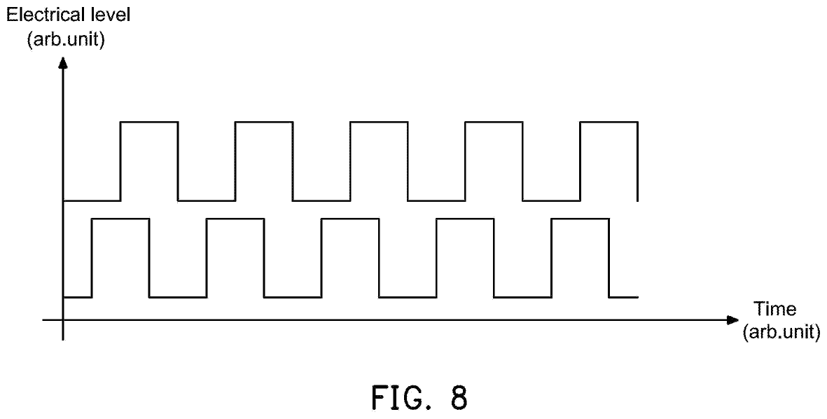

FIG. 8 shows an electrical level-versus-time diagram depicting the cycle signals when the rotary head is operating normally without colliding with any obstacles.

Referring to FIGS. 2, 3 and 8 together, when the rotary head is operating normally without colliding with any obstacles, the photoelectric encoder 6 can generate the cycle signals having alternative high and low electrical levels. The angle detecting unit 71 can receive the cycle signals and detect angular positions of the code disk 61 according to the cycle signals. In one embodiment, the code disk 61 has a plurality of slits 611 that are periodically arranged on the code disk 61.

For example, if the number of the slits is 4, then the cycle signal includes 4 pulse cycles when the code disk 61 rotates 360 degrees, indicating that one pulse cycle corresponds to an angular displacement when the code disk 61 rotates 90 degrees. Similarly, if the number of the slits is 8, then the cycle signal includes 8 pulse cycles when the code disk 61 rotates 360 degrees, indicating that one pulse cycle corresponds to an angular displacement when the code disk 61 rotates 45 degrees. As such, the angular displacement and position of the code disk 61 can be determined by the number of pulse cycles in the cycle signal and the total number of the slits of the code disk 61.

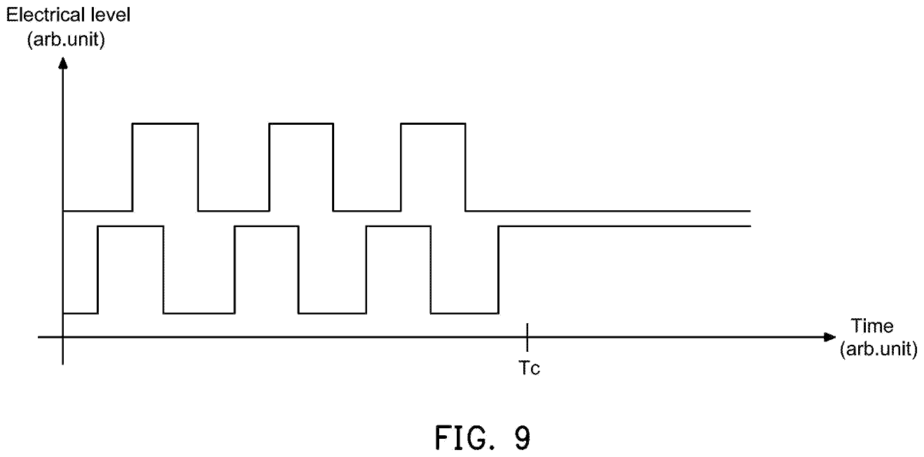

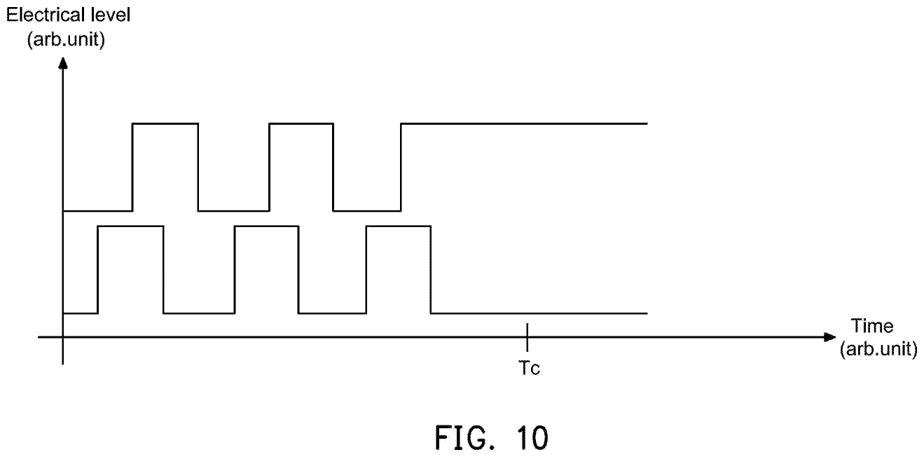

FIG. 9 shows an electrical level-versus-time diagram depicting the cycle signals when the rotary head hits an obstacle at the collision time Tc. FIG. 10 shows an electrical level-versus-time diagram depicting the operation of the rotary head when it hits an obstacle at the collision time Tc.

Despite variations in the electrical levels corresponding to high or low status, the cycle signals remain constant and reach invariant electrical levels when the rotary head 1 encounters an obstacle at the collision time Tc, as shown in both FIGS. 9 and 10. Accordingly, the obstacle detecting unit 73 can generate an obstacle signal when the cycle signals reach invariant electrical levels.

To avoid a double collision with the obstacle, the driving circuit 75 can set the current angular position as a limit value of a preset rotation range when receiving the obstacle signal. Then, the driving circuit 75 can generate driving signals for the motor 5 based on the preset rotation range that has been updated after the first time collision.

For instance, the rotary head is set with a preset rotation range of oscillating toward −45 degrees to the left and 45 degrees to the right, the rotary head 1 collides with the obstacle while oscillating −30 degrees to the left at the collision time Tc. Then, the cycle signals reach invariant electrical levels, and the obstacle detecting unit 73 can generate an obstacle signal, indicating that the rotary head hits an obstacle. In order to avoid double impact on the obstacle, the driving circuit 75 sets the current angular position, −30 degrees to the left, as an updated limit value of the preset rotation range when receiving the obstacle signal. Then, the driving circuit 75 generates driving signals for the motor 5 based on the preset rotation range of oscillating toward −30 degrees to the left and 45 degrees to the right.

Referring to FIG. 3 again, in another embodiment, the controller 7 further includes a reversing unit 77. The reversing unit 77 is electrically coupled to the driving circuit 75. The reversing unit 77 can generate a reversing signal in response to the obstacle signal. The driving circuit 75 can reverse a direction of rotation of the motor 5 according to the reversing signal. This allows the motor 5 to rotate the rotary head 1 in the opposite direction to prevent further damage to the mechanism of the rotary head 1 and the motor 5.

In one embodiment, the controller 7 further includes a preset unit 79. The preset unit 79 can reset the limit value of the preset rotation range. For example, if the preset unit 79 resets the limits of the preset rotation range, the calibrated preset rotation range of −30 degrees to the left and 45 degrees to the right will be reset to the original preset rotation range of −45 degrees to the left and 45 degrees to the right. Thus, the driving circuit 75 generates driving signals for the motor 5 based on the original preset rotation range of oscillating toward −45 degrees to the left and 45 degrees to the right.

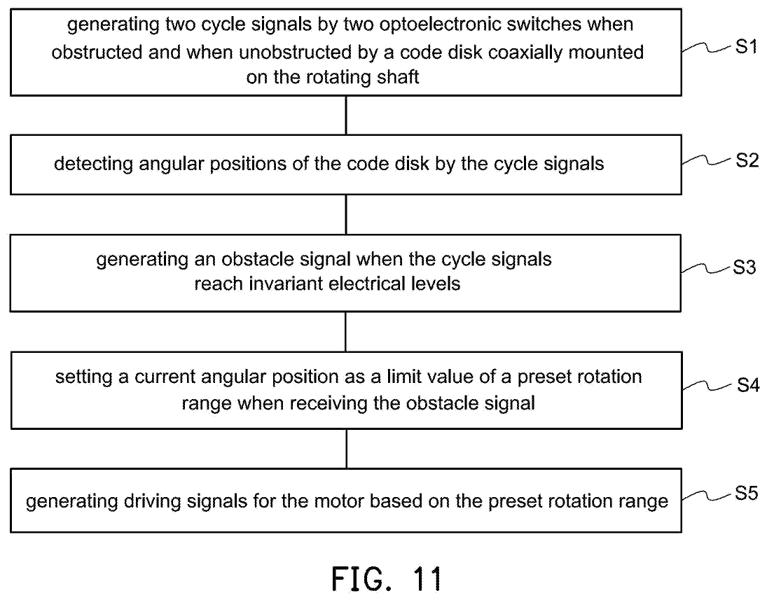

FIG. 11 shows a flowchart of another embodiment of a method for avoiding double impact on obstacles for a rotary head having a rotating shaft driven by a motor. The method includes:
step S1: generating two cycle signals by two optoelectronic switches when obstructed and when unobstructed by a code disk coaxially mounted on the rotating shaft;
step S2: detecting angular positions of the code disk by the cycle signals;
step S3: generating an obstacle signal when the cycle signals reach invariant electrical levels;
step S4: setting a current angular position as a limit value of a preset rotation range when receiving the obstacle signal; and
step S5: generating driving signals for the motor based on the preset rotation range.

The aforementioned steps of the methods can be implemented through one or more embodiments of the obstacle avoidance system mentioned above, thus avoiding redundant repetition of the technical function, results, and advantages.

In one embodiment, the method further includes steps of generating a reversing signal in response to the obstacle signal and reversing the direction of rotation of the motor. This can be implemented through the embodiments mentioned above and allows the motor to rotate the rotary head in the opposite direction to prevent further damage to the mechanism of the rotary head and the motor.

In one embodiment, the step S2 of detecting angular positions of the code disk may further include determining the angular positions by the cycle signals and the total number of the slits that are periodically arranged on the code disk. The total number of the slits of the code disk can be 4, 8, 12, or other suitable number N. Similar examples have been discussed in the previous embodiments, and they are not repeated here to avoid redundancy. Thus, one pulse cycle corresponds to an angular displacement when the code disk rotates 360/N degrees.

In one embodiment, the step S2 of detecting angular positions of the code disk may further include determining a rotating direction of the code disk by a phase difference between the cycle signals that include alternative high and low electrical levels. As mentioned above, comparing FIGS. 5 and 7 reveals that the signal phase difference between the two cycle signals V1, V2 will vary as the code disk rotates clockwise or counterclockwise. Similar examples have been discussed in the previous embodiments, and they are not repeated here to avoid redundancy.

In one embodiment, the method further includes a step of resetting the limit value of the preset rotation range. This allows the controller to reset the calibrated preset rotation range to its original values when the obstacles do not exist after the first collision as mentioned above.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

The terms and expressions used herein have the ordinary meaning accorded to such terms and expressions in their respective areas, except where specific meanings have been set forth. Relational terms such as “left” and “right” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

What is claimed is:

1. An obstacle avoidance system for a rotating shaft driven by a motor comprising:
a photoelectric encoder including:
a code disk coaxially mounted on the rotating shaft and having a plurality of slits within a periphery of the code disk; and
a photoelectric sensor comprising two optoelectronic switches spaced apart and oriented towards the code disk, wherein the two optoelectronic switches can generate two cycle signals when obstructed and when unobstructed by the code disk; and
a controller electrically coupled to the photoelectric encoder and including:
an angle detecting unit that can detect angular positions of the code disk by the cycle signals;
an obstacle detecting unit that can generate an obstacle signal when the cycle signals reach invariant electrical levels; and
a driving circuit electrically coupled to the obstacle detecting unit and the angle detecting unit that can set a current angular position as a limit value of a preset rotation range when receiving the obstacle signal and can generate driving signals for the motor based on the preset rotation range.

2. The obstacle avoidance system of claim 1, wherein the controller further comprises:
a reversing unit electrically coupled to the driving circuit that can generate a reversing signal in response to the obstacle signal, wherein the driving circuit can reverse a direction of rotation of the motor.

3. The obstacle avoidance system of claim 1, wherein the slits are periodically arranged on the code disk, and the angular positions of the code disk can be determined by the cycle signals and a total number of the slits.

4. The obstacle avoidance system of claim 1, wherein each of the optoelectronic switches can respectively generate the cycle signal including alternative high and low electrical levels, and wherein the angle detecting unit can determine a rotating direction of the code disk by a phase difference between the cycle signals.

5. The obstacle avoidance system of claim 1, wherein the controller further comprises:
a preset unit that can reset the limit value of the preset rotation range.

6. A method for avoiding double impact on obstacles for a rotary head having a rotating shaft driven by a motor comprising:
generating two cycle signals by two optoelectronic switches when obstructed and when unobstructed by a code disk coaxially mounted on the rotating shaft;
detecting angular positions of the code disk by the cycle signals;
generating an obstacle signal when the cycle signals reach invariant electrical levels;
setting a current angular position as a limit value of a preset rotation range when receiving the obstacle signal; and
generating driving signals for the motor based on the preset rotation range.

7. The method of claim 6, further comprising:
when receiving the obstacle signal, generating a reversing signal in response to the obstacle signal; and
reversing a direction of rotation of the motor.

8. The method of claim 6, wherein the detecting angular positions of the code disk further comprises:
determining the angular positions by the cycle signals and a total number of the slits that are periodically arranged on the code disk.

9. The method of claim 6, wherein the detecting angular positions of the code disk further comprises:
determining a rotating direction of the code disk by a phase difference between the cycle signals that include alternative high and low electrical levels.

10. The method of claim 6, further comprising:
when the obstacles do not exist, resetting the limit value of the preset rotation range.
